(19) United States
(12) Patent Application Publication
(10) Pub. No.: US 2020/0393928 A1
(43) Pub. Date: Dec. 17, 2020

(54) TOUCH INPUT SYSTEM, TOUCH INPUT DEVICE, AND TOUCH INPUT AUXILIARY TOOL

(71) Applicant: SHARP KABUSHIKI KAISHA, Sakai City (JP)

(72) Inventor: Hiroya SAITO, Osaka (JP)

(21) Appl. No.: 16/897,605

(22) Filed: Jun. 10, 2020

(30) Foreign Application Priority Data
Jun. 14, 2019 (JP) 2019-111123

(51) Int. Cl. G06F 3/041

(52) U.S. Cl. CPC G06F 3/0416

(57) ABSTRACT

A touch input system includes a touch input device and a touch input auxiliary tool. The touch input device includes a detector, a function addition section, and an input determination section. The detector has a touch input surface and detects touch input to the touch input surface or a position of the touch input auxiliary tool arranged on the touch input surface. The function addition section adds a touch input button function corresponding to the touch input auxiliary tool to a corresponding area that corresponds to the position of the touch input auxiliary tool on the touch input surface in the case where the detector detects the touch input auxiliary tool. The input determination section that determines that input is carried out by the touch input button function added to the corresponding area in the case where the detector detects the touch input to the corresponding area by the touch input object.

### BACKGROUND OF THE INVENTION

### Field of the Invention

The present invention relates to a touch input system, a touch input device, and a touch input auxiliary tool.

### Description of the Background Art

A touch table system described in Japanese Unexamined Patent Application Publication No. 2013-41350 includes a touch table device and an information processor. The touch table device is connected to the information processor.

The touch table device includes a touch position detector and a touch position converter. The touch position detector detects a touch position within a touch detection area. The touch position converter converts coordinates of the touch position that is acquired in an operation area per user set within the touch detection area into coordinates of a screen area of the information processor.

The information processor includes an operation area setting section and a screen operation processor. The operation area setting section sets the operation area per user within the touch detection area on the basis of the touch position acquired by the touch position detector. The screen operation processor reflects processing that is executed in the operation area per user to the same screen area according to the coordinates of the screen area that is converted by the touch position convertor.

The touch table system further includes an area designation tool. When the area designation tool is detected, the operation area setting section sets the operation area on the basis of a mounted position of the area designation tool.

In an input system that includes a touchscreen input device, there is a case where button input is desired to be performed separately from normal touch input. Conventionally, in such a case, in addition to a touchscreen, an electronic input device that includes an input button such as a keyboard or a mouse has to be additionally connected to the input system including the touchscreen input device. However, such a method for connecting the electronic input device in addition to the touchscreen complicates the input system and thus is undesirable from a perspective of convenience.

The present invention has been made in view of the above problem and therefore has an object to provide a touch input system, a touch input device, and a touch input auxiliary tool capable of improving convenience of input to a computer by assigning an input button function onto a touchscreen using the touch input auxiliary tool.

### SUMMARY OF THE INVENTION

According to a first aspect of the present invention, a touch input system includes a touch input device and a touch input auxiliary tool. The touch input device includes a detector, a function addition section, and an input determination section. The detector has a touch input surface and detects touch input to the touch input surface by a touch input object or a position of the touch input auxiliary tool that is arranged on the touch input surface. The function addition section adds a touch input button function corresponding to the touch input auxiliary tool to a corresponding area that corresponds to the position of the touch input auxiliary tool on the touch input surface in the case where the detector detects the touch input auxiliary tool. The input determination section that determines that input is carried out by the touch input button function added to the corresponding area in the case where the detector detects the touch input to the corresponding area by the touch input object.

According to a second aspect of the present invention, a touch input device includes a detector, a function addition section, and an input determination section. The detector has a touch input surface and detects touch input to the touch input surface by a touch input object or a position of a touch input auxiliary tool that is arranged on the touch input surface. The function addition section adds a touch input button function corresponding to the touch input auxiliary tool to a corresponding area that corresponds to the position of the touch input auxiliary tool on the touch input surface in the case where the detector detects the touch input auxiliary tool. The input determination section determines that input is carried out by the touch input button function added to the corresponding area in the case where the detector detects the touch input to the corresponding area by the touch input object.

According to a third aspect of the present invention, a touch input auxiliary tool is detected by the detector of the touch input device according to the second aspect and is associated with the touch input button function.

According to the present invention, it is possible to provide the touch input system, the touch input device, and the touch input auxiliary tool capable of improving the convenience of input to a computer.

### BRIEF DESCRIPTION OF THE DRAWINGS

FIG. 1 is a perspective view illustrating a touch input system according to an embodiment of the present invention.

FIG. 2 is a block diagram illustrating the touch input system according to the present embodiment.

FIG. 3 is a plan view illustrating a first example of a touch input auxiliary tool according to the present embodiment.

FIG. 4 is a perspective view illustrating a state where the touch input auxiliary tool according to the present embodiment is arranged in a touch input device.

FIGS. 5A to 5C are plan views, each of which illustrates an example of an identification section in the touch input auxiliary tool according to the present embodiment.

FIG. 6A is a plan view illustrating a state where the touch input auxiliary tool according to the present embodiment is arranged in the touch input device, and FIG. 6B is a plan view illustrating a corresponding area that corresponds to the touch input auxiliary tool according to the present embodiment.

FIG. 7 is a view illustrating a reference table according to the present embodiment.

FIG. 8 is a plan view illustrating a second example of the touch input auxiliary tool according to the present embodiment.

FIG. 9 is a plan view illustrating a third example of the touch input auxiliary tool according to the present embodiment.

FIG. 10 is a flowchart illustrating processing executed by the touch input device according to the present embodiment.

### DESCRIPTION OF THE PREFERRED EMBODIMENTS

A description will hereinafter be made on an embodiment of the present invention with reference to the drawings. In the drawings, the same or corresponding portions will be denoted by the same reference signs, and the description thereon will not be repeated. In addition, a three-dimensional Cartesian coordinate system (X, Y, will appropriately be illustrated for convenience of description. In the drawings, an X-axis and a Y-axis are parallel to a horizontal direction, and a Z-axis is parallel to a vertical direction.

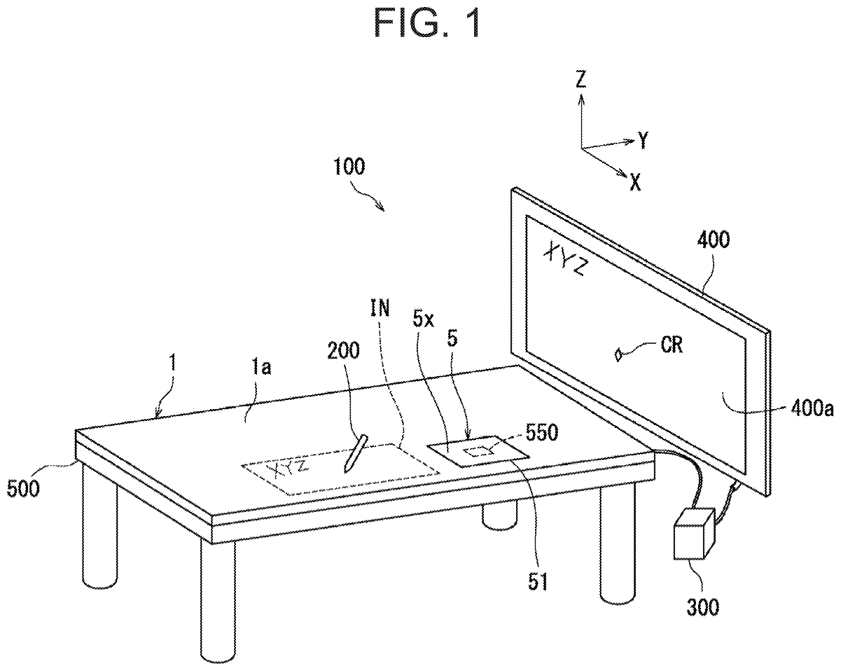

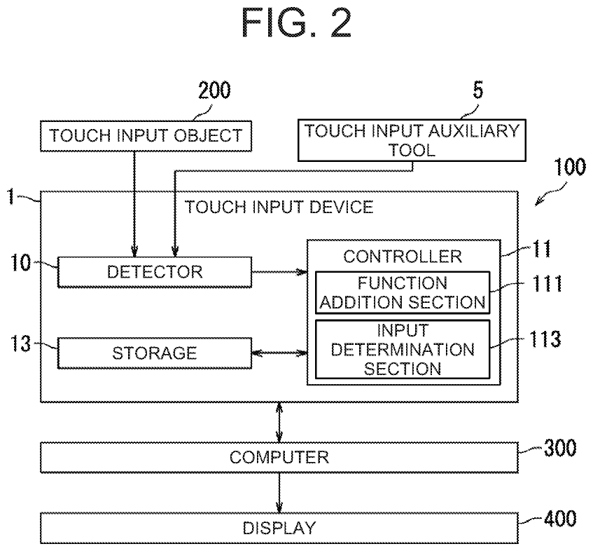

A description will be made on a touch input system 100 according to an embodiment of the present invention with reference to FIG. 1 to FIG. 10. A description will firstly be made on the touch input system 100 with reference to FIG. 1 and FIG. 2.

FIG. 1 is a perspective view illustrating the touch input system 100 according to the present embodiment. As illustrated in FIG. 1, the touch input system 100 includes a touch input device 1, a touch input auxiliary tool 5, a computer 300, and a display 400. The touch input system 100 may further include a touch input object 200.

The touch input device 1 receives touch input from the touch input object 200 and enters input information indicated by the touch input to the computer 300. The touch input device 1 is a touchscreen, for example. In the present embodiment, the touch input device 1 does not have a display. However, the touch input device 1 may have the display.

The touch input device 1 has a substantially flat plate shape. In the present embodiment, the touch input device 1 is installed on a table 500. For example, the touch input device 1 is substantially parallel to the horizontal direction.

The touch input auxiliary tool 5 assists the touch input by the touch input object 200. The touch input auxiliary tool 5 is associated with a touch input button function. The touch input button function is a function as a button that responds to the touch input.

The computer 300 executes information processing and displays an image corresponding to an information processing result on the display 400. In the present embodiment, the computer 300 executes the information processing according to the input information entered from the touch input device 1, and displays the image corresponding to the information processing result on the display 400. The computer 300 is a personal computer, for example. The computer 300 may be included in the touch input device 1.

The display 400 shows the image that is entered from the computer 300. The display 400 is a liquid-crystal display or an organic electroluminescent display, for example. In the case where the touch input device 1 has the display, the touch input system 100 may not include the display 400.

The touch input object 200 is an object that performs the touch input to the touch input device 1. The touch input object 200 is a stylus such as a pen-shaped object used to write on the touchscreen, for example. Here, FIG. 1 illustrates an example in which the touch input object 200 is the stylus. However, the touch input object 200 is not particularly limited as long as capable of performing the touch input. For example, the touch input object 200 may be a finger of a user's hand.

FIG. 2 is a block diagram illustrating the touch input system 100. As illustrated in FIG. 2, the touch input device 1 includes a detector 10, a controller 11, and a storage 13.

As illustrated in FIG. 1 and FIG. 2, the detector 10 has a touch input surface 1a. The detector 10 detects the touch input by the touch input object 200 to the touch input surface 1a. More specifically, the detector 10 detects a touch position on the touch input surface 1a by the touch input object 200, and outputs information on the touch position to the controller 11. The touch position means a touch position on the touch input surface 1a

In addition, the detector 10 detects the touch input auxiliary tool 5 that is arranged on the touch input surface 1a. More specifically, the detector 10 detects a position of the touch input auxiliary tool 5 that is arranged on the touch input surface 1a, and outputs information on the position of the touch input auxiliary tool 5 to the controller 11. The position of the touch input auxiliary tool 5 means a position of the touch input auxiliary tool 5 on the touch input surface 1a. The touch input device 1 may be inclined to the horizontal direction as long as the touch input auxiliary tool 5 that is arranged on the touch input surface 1a does not slide down due to gravity.

The detector 10 is a touch sensor, for example. In the present embodiment, the detector 10 detects the touch input by the touch input object 200 and the position of the touch input auxiliary tool 5 by an electrostatic capacitance method. Accordingly, in the present specification, “touch” is not limited to a case where the touch input object 200 is in direct contact with the touch input surface 1a, and also includes a case where the touch input object 200 separates from the touch input surface 1a within a detectable range of the detector 10. That is, “touch” means that the touch input object 200 is detected by the detector 10. In addition, an object may exist between the touch input surface 1a and the touch input object 200 as long as the detector 10 can detect the touch input object 200. The detection method by the detector 10 is not limited to the electrostatic capacitance method and may be an electromagnetic induction method, for example.

A material for a touch input object 200 is not particularly limited as long as the detector 10 can detect such a material. In the present embodiment, since the detection method by the detector 10 is the electrostatic capacitance method, the touch input object 200 is formed of an electrically conductive object.

The touch input auxiliary tool 5 includes a main body 51. A material for the main body 51 is not particularly limited as long as the detector 10 cannot detect such a material. In the present embodiment, since the detection method by the detector 10 is the electrostatic capacitance method, the main body 51 is formed of an insulator. The insulator is a synthetic resin, paper, or cloth, for example.

The controller 11 controls each component of the touch input device 1. The controller 11 includes a processor such as a central processing unit (CPU).

In the present embodiment, the controller 11 sets an input area IN on the touch input surface 1a. Then, the controller 11 sets one-to-one correspondence between the input area IN and a screen 400a of the display 400. That is, the input area IN is an area in the one-to-one correspondence with the screen 400a. When the detector 10 detects the touch input in the input area IN, the controller 11 calculates the touch position in the input area IN on the basis of the touch position on the touch input surface 1a.

Then, the controller 11 enters the information on the touch position in the input area IN to the computer 300. The computer 300 displays a cursor CR on the display 400 in a manner to correspond to the touch position in the input area IN. In addition, the computer 300 draws an image that corresponds to a movement locus of the touch position in the input area IN on the display 400.

The storage 13 includes a storage device and stores data and a computer program. More specifically, the storage 13 includes a main storage device such as semiconductor memory and an auxiliary storage device such as the semiconductor memory, a solid-state drive, and/or a hard disk drive. The storage 13 may include a removable media.

The controller 11 includes a function addition section 111 and an input determination section 113. More specifically, the processor of the controller 11 executes the computer program that is stored in the storage device of the storage 13, and functions as the function addition section 111 and the input determination section 113.

In the case where the detector 10 detects the touch input auxiliary tool 5, the function addition section 111 adds the touch input button function, which corresponds to the touch input auxiliary tool 5, to a corresponding area 550 corresponding to the position of the touch input auxiliary tool 5 on the touch input surface 1a. Accordingly, the user can easily add the touch input button function to the touch input surface 1a by arranging the touch input auxiliary tool 5 on the touch input surface 1a. As a result, according to the present embodiment, convenience of input to the computer 300 can be improved.

The corresponding area 550 is an area that corresponds to the position of the touch input auxiliary tool 5, and is an area on the touch input surface 1a. In the example illustrated in FIG. 1, on the basis of the single touch input auxiliary tool 5, the function addition section 111 adds the single touch input button function to the single corresponding area 550. However, the single touch input auxiliary tool 5 may be associated with the plurality of touch input button functions. In this case, on the basis of the single touch input auxiliary tool 5, the function addition section 111 adds the plurality of touch input button functions to the plurality of corresponding areas 550.

In the case where the detector 10 detects the touch input to the corresponding area 550 by the touch input object 200, the input determination section 113 determines that the input is performed by the touch input button function added to the corresponding area 550. Then, the input determination section 113 enters information on an input content by the touch input button function to the computer 300. The computer 300 executes the information processing according to the input content by the touch input button function. Accordingly, the user can perform the input to the computer 300 by using the touch input button function associated with the touch input auxiliary tool 5. As a result, according to the present embodiment, the convenience of the input to the computer 300 can be improved.

In particular, in the present embodiment, the function addition section 111 adds the touch input button function to the corresponding area 550 that is located directly under the touch input auxiliary tool 5. Then, the detector 10 detects the touch input to the corresponding area 550, which is located directly under the touch input auxiliary tool 5, via the touch to an upper surface 5x of the touch input auxiliary tool 5 by the touch input object 200. That is, the touch input to the corresponding area 550 is performed via the touch input auxiliary tool 5. Thus, according to the present embodiment, the user can easily use the touch input button function added to the corresponding area 550 by touching the upper surface 5x of the touch input auxiliary tool 5 using the touch input object 200.

In addition, in the present embodiment, the touch input auxiliary tool 5 has such a thickness that the detector 10 can detect the touch input object 200 touching the upper surface 5x of the touch input auxiliary tool 5. In the present embodiment, the detection method by the detector 10 is the electrostatic capacitance method. Thus, the touch input auxiliary tool 5 has such a thickness that the detector 10 can detect a change in electrostatic capacitance even when the touch input is performed via the touch input auxiliary tool 5.

More specifically, the touch input auxiliary tool 5 is in the form of a sheet. Thus, the touch input auxiliary tool 5 is relatively thin. As a result, according to the present embodiment, the detector 10 can easily detect the touch input object 200 that touches the upper surface 5x of the touch input auxiliary tool 5.

Furthermore, in the present embodiment, the touch input button function associated with the touch input auxiliary tool 5 includes an input function as an input device to the computer 300. Accordingly, the function addition section 111 adds the input function as the input device to the corresponding area 550. As a result, the user can use the touch input auxiliary tool 5 as the input device (more specifically, a pseudo input device) by arranging the touch input auxiliary tool 5 on the touch input surface 1a. Therefore, according to the present embodiment, the convenience of the input to the computer 300 can further be improved.

The input device is a human-machine interface such as a pointing device or a keyboard.

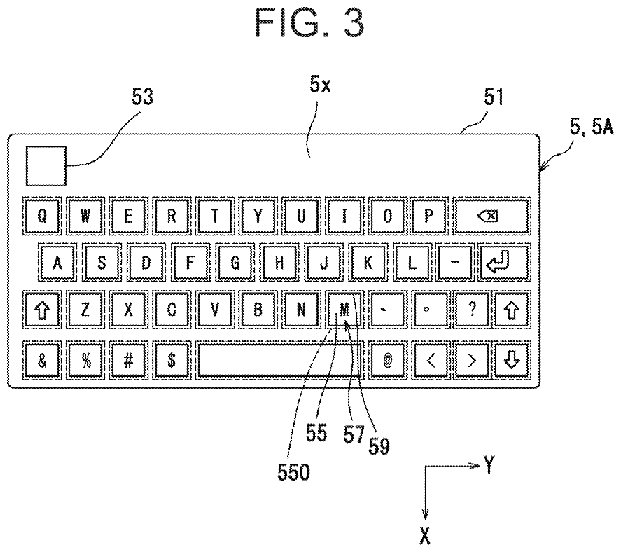

Next, a description will be made on a first example of the touch input auxiliary tool 5 with reference to FIG. 3. The touch input auxiliary tool 5 according to the first example may hereinafter be described as a “touch input auxiliary tool 5A”.

FIG. 3 is a plan view illustrating the touch input auxiliary tool 5A. In FIG. 3, the corresponding areas 550 are indicated by broken lines for convenience of description.

The touch input auxiliary tool 5A illustrated in FIG. 3 is associated with the touch input button function by the keyboard. That is, the touch input button function associated with the touch input auxiliary tool 5A is the input function as the keyboard. Accordingly, the function addition section 111 adds the input function as the keyboard to the corresponding area 550. As a result, the user can use the touch input auxiliary tool 5A as the keyboard (more specifically, a pseudo keyboard) by arranging the touch input auxiliary tool 5A on the touch input surface 1a. Thus, according to the present embodiment, the convenience of the input to the computer 300 can further be improved. The keyboard corresponds to one example of the “input device”.

More specifically, the touch input auxiliary tool 5A is associated with the plurality of touch input button functions, each of which is a key function constituting the keyboard. Accordingly, the function addition section 111 adds the plurality of touch input button functions to the plurality of corresponding areas 550. More specifically, the function addition section 111 adds the plurality of key functions constituting the keyboard to the plurality of corresponding areas 550.

In addition, the touch input auxiliary tool 5A is in the form of the keyboard. Thus, according to the present embodiment, the user can easily recognize that the touch input button functions associated with the touch input auxiliary tool 5A are the input functions as the keyboard. That is, the user can easily recognize that the touch input auxiliary tool 5A can be used as the keyboard (more specifically, the pseudo keyboard).

In the present specification, the “form” means a design, a pattern, a shape, a color, or a combination of some or all of the design, the pattern, the shape, and the color.

More specifically, the touch input auxiliary tool 5A has the form that schematically represents the keyboard. For example, a design schematically representing the keyboard is displayed (for example, marked or printed) on the upper surface 5x or a lower surface of the main body 51 of the touch input auxiliary tool 5A. For example, the main body 51 of the touch input auxiliary tool 5A has the form that schematically represents the keyboard.

Furthermore, at least one of a type (a key type) of each of the touch input button functions associated with the touch input auxiliary tool 5A and a range of each of the corresponding areas 550 is displayed on the touch input auxiliary tool 5A (more specifically, the main body 51). That is, at least one of the type of each of the touch input button functions added to the corresponding area 550 and the range of each of the corresponding areas 550 is displayed on the touch input auxiliary tool 5A. Thus, according to the present embodiment, even in the case where the touch input device 1 does not have the display, the user can easily recognize at least one of the type of each of the touch input button functions and the range of each of the corresponding areas 550 from the display of the touch input auxiliary tool 5A.

More specifically, a symbol 55 that represents at least one of the type (the key type) of each of the touch input button functions added to the corresponding area 550 and the range of each of the corresponding areas 550 is displayed (for example, marked or printed) on the touch input auxiliary tool 5A. In the example illustrated in FIG. 3, the plurality of symbols 55 are displayed (for example, marked or printed) on the main body 51 in a manner to correspond to the plurality of touch input button functions (plurality of keys). Each of the plurality of symbols 55 includes a symbol 57 and a symbol 59.

In the present specification, the “symbol” means a character, a number, a mark, the design, or a combination of some or all of the character, the number, the mark, and the design.

In the example illustrated in FIG. 3, the symbol 57 that represents the type (the key type) of the touch input button function added to the corresponding area 550 is displayed (for example, marked or printed) on the upper surface 5x or the lower surface of the main body 51. That is, when the symbol 57 (for example, a character “M”) that is assigned to the key of the keyboard is displayed (for example, marked or printed) on the upper surface 5x or the lower surface of the main body 51, the type of the touch input button function, that is, a type of the key that corresponds to the touch input button function (for example, the character “M”) is presented. Thus, the user can easily recognize the type and a position of the key that corresponds to the touch input button function added to the corresponding area 550.

In addition, in the example illustrated in FIG. 3, the symbol 59 that represents the range of the corresponding area 550 is displayed (for example, marked or printed) on the upper surface 5x or the lower surface of the main body 51. That is, when the symbol 59 (for example, a design representing a square) that represents a shape of the key of the keyboard is displayed (for example, marked or printed) on the upper surface 5x or the lower surface of the main body 51, the range of the corresponding area 550, that is, a range of the key that corresponds to the corresponding area 550 is presented. Accordingly, the user can easily recognize the range and a position of the key that corresponds to the corresponding area 550. In FIG. 3, in order to facilitate view of the drawing, solid lines indicating the symbol 59 and broken lines indicating the corresponding area 550 are illustrated in a displaced manner.

In the case where the detector 10 detects the touch input to the corresponding area 550, the input determination section 113 illustrated in FIG. 2 determines that the input by the touch input button function that is added to the corresponding area 550 is performed. As an example, the types of the keys of the keyboard (a return key, a space key, a character “Q” key, a number “1” key, and the like) are assigned as the touch input button functions to the corresponding areas 550. When the detector 10 detects the touch input to any of the corresponding areas 550, the input determination section 113 determines that respective one of these keys is entered.

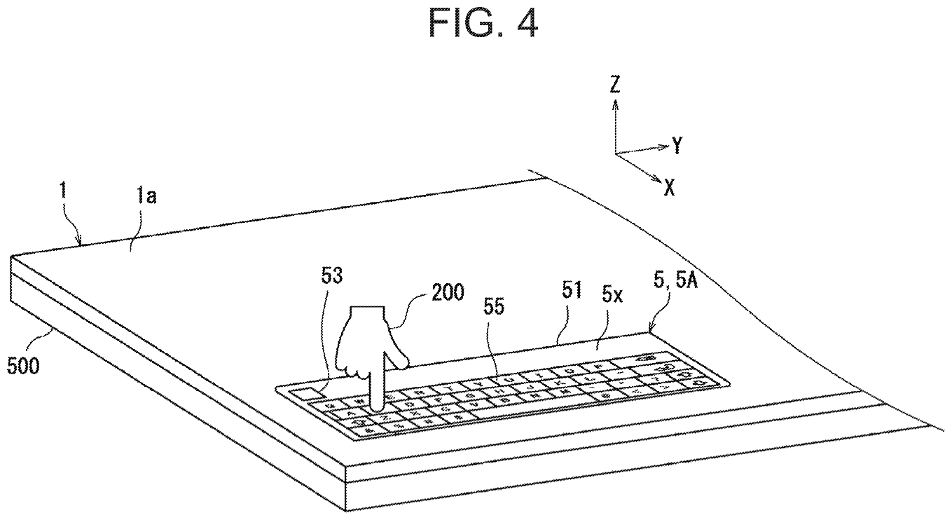

Next, a description will be made on a method for using the touch input auxiliary tool 5A with reference to FIG. 4. FIG. 4 is a perspective view illustrating a state where the touch input auxiliary tool 5A is arranged in the touch input device 1.

As illustrated in FIG. 4, the user arranges the touch input auxiliary tool 5A on the touch input surface 1a. Then, the user uses the touch input object 200 to touch the symbol 55, which represents the desired touch input button function, of the plurality of symbols 55 in the touch input auxiliary tool 5A. As a result, the touch input device 1 enters the input content (more specifically, key information) by the touch input button function (more specifically, the key function of the keyboard), which is added to the corresponding area 550 directly under the symbol 55, to the computer 300.

Here, as illustrated in FIG. 4, the touch input auxiliary tool 5 further includes an identification section 53 in addition to the sheet-like main body 51. The identification section 53 has identification information used to identify a type of the touch input auxiliary tool 5. Hereinafter, the “identification information used to identify the type of the touch input auxiliary tool 5” may be referred to as the “identification information of the touch input auxiliary tool 5”. The identification section 53 has a substantially flat shape. In the present embodiment, since the detection method by the detector 10 is the electrostatic capacitance method, the identification section 53 is electrically conductive.

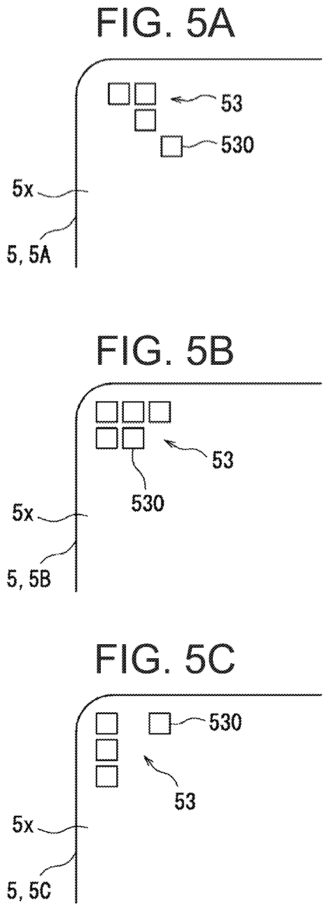

FIG. 5A to FIG. 5C are views, each of which illustrates an example of the identification section 53. As illustrated in FIG. 5A to FIG. 5C, the identification section 53 includes a plurality of conductive elements 530. Each of the plurality of conductive elements 530 is conductive. With a unique arrangement pattern of the plurality of conductive elements 530, the identification section 53 constitutes the identification information of the touch input auxiliary tool 5. In the example illustrated in each of FIG. 5A to FIG. 5C, the plurality of conductive elements 530 are arranged asymmetrically in the single identification section 53.

In the case where the detection method by the detector 10 is the electromagnetic induction method, for example, the identification section 53 is formed of an electromagnetic induction tag. The electromagnetic induction tag includes a coil.

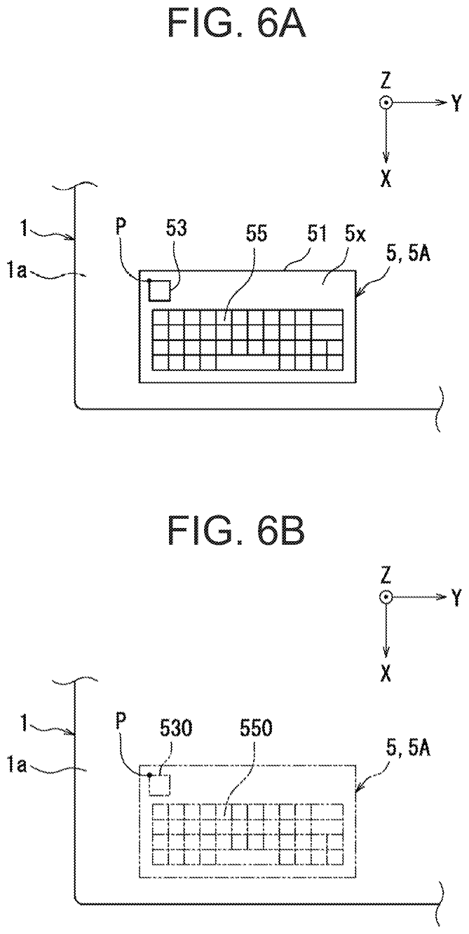

Next, a detailed description will be made on processing executed by the controller 11 with reference to FIG. 2 and FIG. 6A to FIG. 7. FIG. 6A is a plan view illustrating a state where the touch input auxiliary tool 5 is arranged on the touch input surface 1a. FIG. 6B is a plan view illustrating the plurality of corresponding areas 550 that correspond to the touch input auxiliary tool 5.

As illustrated in FIG. 2 and FIG. 6A, when the touch input auxiliary tool 5 is arranged on the touch input surface 1a, the detector 10 detects the position of the touch input auxiliary tool 5. More specifically, the detector 10 detects a position of the identification section 53 in the touch input auxiliary tool 5. Further more specifically, the detector 10 detects a position of each of the conductive elements 530 (FIG. 5) that constitutes the identification section 53.

The detector 10 outputs position information indicative of the position of the touch input auxiliary tool 5 (hereinafter may be described as “position information PS”) to the controller 11. More specifically, the position information PS indicates the position of the identification section 53. Further more specifically, the position information PS indicates the position of each of the conductive elements 530 that constitute the identification section 53.

The function addition section 111 specifies a position P of the touch input auxiliary tool 5 on the basis of the position information PS of the touch input auxiliary tool 5.

More specifically, the function addition section 111 specifies the position P of the touch input auxiliary tool 5 on the basis of the position of the identification section 53. For example, the function addition section 111 sets the position of the identification section 53 as the position P of the touch input auxiliary tool 5.

Further more specifically, the function addition section 111 specifies the position P of the touch input auxiliary tool 5 on the basis of the position of one or more of the conductive elements 530 among the plurality of conductive elements 530 (FIG. 5) that constitute the identification section 53. For example, the function addition section 111 sets the position of the conductive element 530, which is located at a specified position, among the plurality of conductive elements 530 as the position P of the touch input auxiliary tool 5. In the example illustrated in FIG. 6A, the specified position is a position at an upper left corner of the identification section 53.

A method for specifying the position of the touch input auxiliary tool 5 is not particularly limited as long as the position of the touch input auxiliary tool 5 can be specified. For example, the function addition section 111 may set an average value of the positions of the plurality of conductive elements 530 (FIG. 5) as the position P of the touch input auxiliary tool 5.

The function addition section 111 acquires the identification information of the touch input auxiliary tool 5 on the basis of a detection result of the identification section 53 by the detector 10. In the present embodiment, the function addition section 111 analyzes the position information PS of the touch input auxiliary tool 5 and thereby acquires the identification information of the touch input auxiliary tool 5.

More specifically, the function addition section 111 specifies the arrangement pattern of the plurality of conductive elements 530 on the basis of the positions of the plurality of conductive elements 530 that constitute the identification section 53. Then, the function addition section 111 acquires the identification information of the touch input auxiliary tool 5 on the basis of the specified arrangement pattern. For example, the storage 13 stores an arrangement pattern table (hereinafter described as an “arrangement pattern table AP”). In the arrangement pattern table AP, for each of the plurality of arrangement patterns, the arrangement pattern and the identification information of the touch input auxiliary tool 5 are associated with each other. Then, the function addition section 111 acquires the identification information of the touch input auxiliary tool 5 that is associated with the specified arrangement pattern from the arrangement pattern table AP.

As illustrated in FIG. 6B, the function addition section 111 sets the corresponding area 550 on the touch input surface 1a in the manner to correspond to the touch input auxiliary tool 5 that is presented by the identification information acquired from the arrangement pattern table AP. In the example illustrated in FIG. 6B, the function addition section 111 sets the plurality of corresponding areas 550 on the touch input surface 1a in the manner to correspond to the touch input auxiliary tool 5. More specifically, the function addition section 111 sets the plurality of corresponding areas 550 in the manner to correspond to the plurality of symbols 55 illustrated in FIG. 6A, respectively. In this case, the function addition section 111 sets one-to-one correspondence between each of the symbols 55 and respective one of the corresponding areas 550, and sets the corresponding area 550 directly under each of the symbols 55.

More specifically, the function addition section 111 sets the corresponding areas 550 on the touch input surface 1a on the basis of the identification information of the touch input auxiliary tool 5 and a reference table TB. The reference table TB is stored in the storage 13.

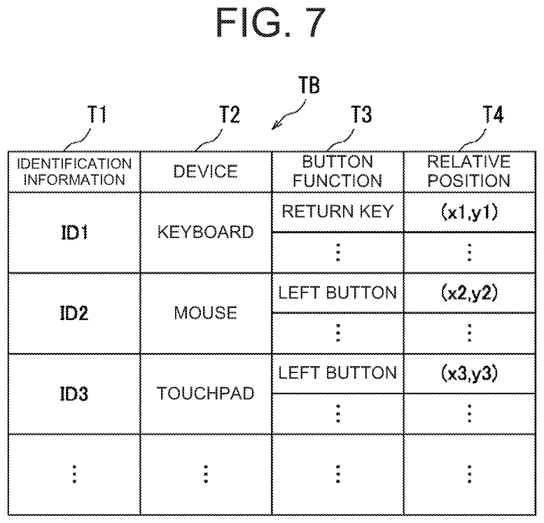

FIG. 7 is a view illustrating the reference table TB. As illustrated in FIG. 7, in the reference table TB, for each identification information T1 of the touch input auxiliary tool 5, the identification information T1 of the touch input auxiliary tool 5, information T2 on the type of the input device, information T3 on the type of the touch input button function, and information T4 on a relative position of the corresponding area 550 to the position P of the touch input auxiliary tool 5 (FIG. 6) are associated. In addition, the information T4 on the relative position of the corresponding area 550 is associated with information on size and a shape of the corresponding area 550. The information T2 on the type of the input device may be associated with information on size of the touch input auxiliary tool 5.

The function addition section 111 illustrated in FIG. 2 acquires the information T4 on the relative position of the corresponding area 550 from the reference table TB on the basis of the identification information T1 of the touch input auxiliary tool 5. Then, the function addition section 111 sets the corresponding area 550 on the touch input surface 1a on the basis of the information T4 on the relative position of the corresponding area 550.

In the case where the detector 10 detects the touch input auxiliary tool 5, the function addition section 111 acquires the information T2 on the type of the input device and the information T3 on the type of the touch input button function from the reference table TB on the basis of the identification information T1 of the touch input auxiliary tool 5. Then, the function addition section 111 adds the touch input button function corresponding to the type of the input device to the corresponding area 550 on the basis of the information T2 on the type of the input device and the information T3 on the type of the touch input button function.

In the case where the detector 10 detects the touch input to the corresponding area 550 by the touch input object 200, the input determination section 113 illustrated in FIG. 2 refers to the reference table TB and specifies the corresponding area 550 that includes the touch position by the touch input object 200 from the plurality of corresponding areas 550. Then, the input determination section 113 refers to the reference table TB, and determines that the input is performed by the touch input button function added to the specified corresponding area 550 on the basis of the information T2 on the type of the input device that is associated with the specified corresponding area 550 and the information T3 on the type of the touch input button function that is associated with the specified corresponding area 550.

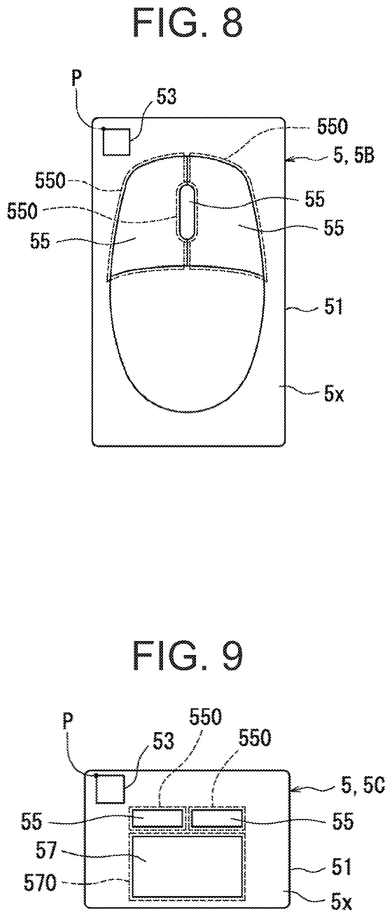

Next, a description will be made on a second example of the touch input auxiliary tool 5 with reference to FIG. 8. Hereinafter, the touch input auxiliary tool 5 according to the second example may be described as a “touch input auxiliary tool 5B”.

FIG. 8 is a plan view illustrating the touch input auxiliary tool 5B. In FIG. 8, for convenience of description, the corresponding areas 550 are indicated by broken lines. FIG. 8 illustrates the three corresponding areas 550.

The touch input auxiliary tool 5B illustrated in FIG. 8 is associated with the touch input button function by a mouse. That is, the touch input button function associated with the touch input auxiliary tool 5B is the input function as the mouse. Accordingly, the function addition section 111 adds the input function as the mouse to each of the corresponding areas 550. As a result, the user can use the touch input auxiliary tool 5B as the mouse (more specifically, a pseudo mouse) by arranging the touch input auxiliary tool 5B on the touch input surface 1a. Thus, according to the present embodiment, the convenience of the input to the computer 300 can further be improved. The mouse corresponds to an example of the “input device”.

More specifically, the touch input auxiliary tool 5B is associated with the three touch input button functions that are a function as a left button, a function as a right button, and a function as a wheel button that constitute the mouse. Accordingly, the function addition section 111 adds the three touch input button functions to the three corresponding areas 550.

In addition, the touch input auxiliary tool 5B is in the form of the mouse. Thus, according to the present embodiment, the user can easily recognize that the touch input auxiliary tool 5B can be used as the mouse (more specifically, the pseudo mouse).

More specifically, the touch input auxiliary tool 5B has the form that schematically represents the mouse. For example, a design schematically representing the mouse is displayed (for example, marked or printed) on the upper surface 5x or a lower surface of the main body 51 of the touch input auxiliary tool 5B. For example, the main body 51 of the touch input auxiliary tool 5B may have the form that schematically represents the mouse.

Furthermore, the symbol 55 that represents at least one of the type (the mouse button type) of each of the touch input button functions added to the corresponding area 550 and the range of each of the corresponding areas 550 is displayed (for example, marked or printed) on the touch input auxiliary tool 5B (more specifically, the main body 51). In the example illustrated in FIG. 8, the three symbols 55 are displayed (for example, marked or printed) on the main body 51 in a manner to correspond to the three touch input button functions.

In the example illustrated in FIG. 8, the symbol 55 (for example, the design in a shape corresponding to the button) that represents a shape of the mouse button (the left button, the right button, or the wheel button) is displayed (for example, marked or printed) on the upper surface 5x or the lower surface of the main body 51. In this way, the type of the touch input button function, that is, the button type corresponding to the touch input button function (the left button, the right button, or the wheel button) and the range of the corresponding area 550, that is, a range of the button (the left button, the right button, or the wheel button) corresponding to the corresponding area 550 are presented. In FIG. 8, in order to facilitate view of the drawing, solid lines indicating the symbol 55 and the broken lines indicating the corresponding area 550 are illustrated in the displaced manner.

In the case where the detector 10 detects the touch input to the corresponding area 550, the input determination section 113 illustrated in FIG. 2 determines that the input is performed by the touch input button function added to the corresponding area 550. The input content indicates the mouse button type (the left button, the right button, or the wheel button).

The user uses the touch input object 200 to touch the symbol 55, which represents the desired touch input button function, of the three symbols 55 of the touch input auxiliary tool 5B. As a result, the touch input device 1 enters the input content (more specifically, button information) by the touch input button function (more specifically, the mouse button function) that is added to the corresponding area 550 directly under the symbol 55 to the computer 300.

The user may move the touch input auxiliary tool 5B on the touch input surface 1a. Also, in this case, the detector 10 successively outputs the position information PS indicative of the position of the moving touch input auxiliary tool 5B to the controller 11. Accordingly, the function addition section 111 of the controller 11 successively specifies the position P of the moving touch input auxiliary tool 5B on the basis of the position information PS of the moving touch input auxiliary tool 5B. Then, the function addition section 111 successively enters information on the position P of the moving touch input auxiliary tool 5B to the computer 300. The computer 300 moves the cursor CR displayed on the display 400 in a manner to correspond to the position P of the moving touch input auxiliary tool 5B.

Next, a description will be made on a third example of the touch input auxiliary tool 5 with reference to FIG. 9. Hereinafter, the touch input auxiliary tool 5 according to the third example may be described as a “touch input auxiliary tool 5C”.

FIG. 9 is a plan view illustrating the touch input auxiliary tool 5C. In FIG. 9, for convenience of description, the corresponding areas 550 are indicated by broken lines. FIG. 9 illustrates the two corresponding areas 550.

The touch input auxiliary tool 5C illustrated in FIG. 9 is associated with the touch input button function by a touchpad. That is, the touch input button function associated with the touch input auxiliary tool 5C is the input function as the touchpad. Accordingly, the function addition section 111 adds the input function as the touchpad to each of the corresponding areas 550. As a result, the user can use the touch input auxiliary tool 5C as the touchpad (more specifically, a pseudo touchpad) by arranging the touch input auxiliary tool 5C on the touch input surface 1a. Thus, according to the present embodiment, the convenience of the input to the computer 300 can further be improved. The touchpad corresponds to one example of the “input device”.

More specifically, the touch input auxiliary tool 5C is associated with the two touch input button functions that are a left button function and a right button function constituting the touchpad. Thus, the function addition section 111 adds the two touch input button functions to the two corresponding areas 550, respectively.

In addition, the touch input auxiliary tool 5C is in the form of the touchpad. Thus, according to the present embodiment, the user can easily recognize that the touch input auxiliary tool 5C can be used as the touchpad (more specifically, the pseudo touchpad).

More specifically, the touch input auxiliary tool 5C has the form that schematically represents the touchpad. For example, a design schematically representing the touchpad is displayed (for example, marked or printed) on the upper surface 5x or a lower surface of the main body 51 of the touch input auxiliary tool 5C. For example, the main body 51 of the touch input auxiliary tool 5C has the form that schematically represents the touchpad.

Furthermore, the symbol 55 that represents at least one of the type (a touchpad button type) of each of the touch input button functions added to the corresponding area 550 and the range of each of the corresponding areas 550 is displayed (for example, marked or printed) on the touch input auxiliary tool 5C (more specifically, the main body 51). In the example illustrated in FIG. 9, the two symbols 55 are displayed (for example, marked or printed) on the main body 51 in a manner to correspond to the two touch input button functions.

In the example illustrated in FIG. 9, the symbol 55 (for example, the design in a shape corresponding to the button) that represents a shape of the touchpad button (a left button or a right button) is displayed (for example, marked or printed) on the upper surface 5x or the lower surface of the main body 51. In this way, the type of the touch input button function, that is, the button type corresponding to the touch input button function (the left button or the right button) and the range of the corresponding area 550, that is, a range of the button (the left button or the right button) corresponding to the corresponding area 550 are presented. In FIG. 9, in order to facilitate view of the drawing, solid lines indicating the symbol 55 and the broken lines indicating the corresponding area 550 are illustrated in the displaced manner.

In the case where the detector 10 detects the touch input to the corresponding area 550, the input determination section 113 illustrated in FIG. 2 determines that the input is performed by the touch input button function added to the corresponding area 550. The input content indicates the touchpad button type (the left button or the right button).

The user uses the touch input object 200 to touch the symbol 55, which represents the desired touch input button function, of the two symbols 55 of the touch input auxiliary tool 5C. As a result, the touch input device 1 enters the input content (more specifically, the button information) by the touch input button function (more specifically, the touchpad button function) that is added to the corresponding area 550 directly under the symbol 55 to the computer 300.

The touch input auxiliary tool 5C is also associated with a slide pad function that represents a function of a slide pad constituting the touchpad. The function addition section 111 adds the slide pad function to a corresponding area 570 that corresponds to a position of the touch input auxiliary tool 5C on the touch input surface 1a. The corresponding area 570 is an area that corresponds to the position of the touch input auxiliary tool 5C, and is an area on the touch input surface 1a. A position of the corresponding area 570 differs from the positions of the corresponding areas 550. In the case where the detector 10 detects the touch input by the corresponding area 570, the input determination section 113 enters information on a touch position within the corresponding area 570 to the computer 300. The computer 300 displays the cursor CR on the display 400 in a manner to correspond to the touch position within the corresponding area 570. In this case, the corresponding area 570 and the screen 400a of the display 400 have one-to-one correspondence.

The touch input auxiliary tool 5 illustrated in each of FIG. 3, FIG. 8, and FIG. 9 may have the plurality of identification sections 53. In this case, the size of the touch input auxiliary tool 5 can be detected with a high degree of accuracy. Accordingly, the function addition section 111 can accurately add the corresponding area 550 in a manner to correspond to the size of the touch input auxiliary tool 5. For example, in the case where the main body 51 of the touch input auxiliary tool 5 has a substantially rectangular shape, the identification section 53 is arranged at each of two corners of the main body 51 on a diagonal line of the main body 51.

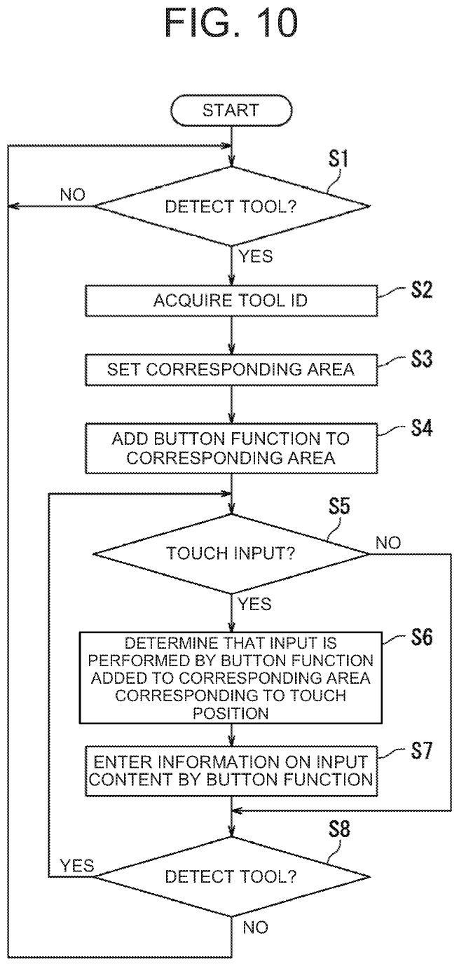

Next, a description will be made on the processing executed by the controller 11 of the touch input device 1 with reference to FIG. 2 and FIG. 10. FIG. 10 is a flowchart illustrating the processing executed by the controller 11. As illustrated in FIG. 10, the processing includes step S1 to step S8.

As illustrated in FIG. 2 and FIG. 10, in step S1, the function addition section 111 determines whether the detector 10 detects the touch input auxiliary tool 5.

If it is determined in step S1 that the detector 10 does not detect the touch input auxiliary tool 5 (NO), the processing in step S1 is repeated. For example, in the case where the detector 10 does not output the position information PS of the touch input auxiliary tool 5, or in the case where the detector 10 outputs a specific signal SG indicating that the detector 10 does not detect the touch input auxiliary tool 5, the function addition section 111 determines that the detector 10 does not detect the touch input auxiliary tool 5.

On the other hand, if it is determined in step S1 that the detector 10 detects the touch input auxiliary tool 5 (YES), the processing proceeds to step S2. For example, in the case where the detector 10 outputs the position information PS of the touch input auxiliary tool 5, or in the case where the detector 10 outputs the specific signal SG indicating that the detector 10 detects the touch input auxiliary tool 5, the function addition section 111 determines that the detector 10 detects the touch input auxiliary tool 5.

In step S2, the function addition section 111 acquires the identification information (ID) of the touch input auxiliary tool 5 on the basis of the detection result of the identification section 53 by the detector 10.

In step S3, the function addition section 111 sets the plurality of corresponding areas 550 on the touch input surface 1a on the basis of the identification information (ID) of the touch input auxiliary tool 5 and the reference table TB (FIG. 7).

In step S4, the function addition section 111 adds the plurality of touch input button functions to the plurality of corresponding areas 550 on the basis of the identification information (ID) of the touch input auxiliary tool 5 and the reference table TB (FIG. 7).

In step S5, the input determination section 113 determines whether the detector 10 detects the touch input to the corresponding area 550.

If it is determined in step S5 that the touch input to the corresponding area 550 is not detected (NO), the processing proceeds to step S8.

On the other hand, if it is determined in step S5 that the touch input to the corresponding area 550 is detected (YES), the processing proceeds to step S6.

In step S6, the input determination section 113 determines that the input is performed by the touch input button function that is added to the corresponding area 550 corresponding to the touch position on the basis of the reference table TB (FIG. 7). More specifically, the input determination section 113 specifies the corresponding area 550 including the touch position from the plurality of corresponding areas 550 on the basis of the reference table TB. Then, the input determination section 113 determines that the input is performed by the touch input button function that is added to the specified corresponding area 550 on the basis of the reference table TB.

In step S7, the input determination section 113 enters information on the input content by the touch input button function to the computer 300.

In step S8, similar to step S1, the input determination section 113 determines whether the detector 10 detects the touch input auxiliary tool 5.

If it is determined in step S8 that the detector 10 does not detect the touch input auxiliary tool 5 (NO), the processing proceeds to step S1.

On the other hand, if it is determined in step S8 that the detector 10 detects the touch input auxiliary tool 5 (YES), the processing proceeds to step S5.

As it has been described so far with reference to FIG. 10, according to the present embodiment, in the case where the detector 10 detects the touch input auxiliary tool 5, the function addition section 111 adds the touch input button function, which corresponds to the touch input auxiliary tool 5, to the corresponding area 550 on the touch input surface 1a. Thus, the user can easily add the touch input button function to the touch input surface 1a by arranging the touch input auxiliary tool 5 on the touch input surface 1a.

The description has been made so far on the embodiment of the present invention with reference to the drawings. However, the present invention is not limited to the above embodiment and can be implemented in various aspects within the scope that does not depart from the gist thereof. In addition, the plurality of components disclosed in the above embodiment can appropriately be changed. For example, a certain component of all of the components described in the embodiment may be added to the components in another embodiment, or some components of all of the components described in the embodiment may be eliminated from the embodiment.

In each of the drawings, each of the components is schematically illustrated in order to facilitate understanding of the invention, and a thickness, a length, the number, a clearance, and the like of each of the illustrated components may differ from the actual length, number, clearance, and the like for convenience of drafting the drawings. In addition, the configuration of each of the components described in the above embodiment merely constitutes one example and thus is not particularly limited thereto. It is needless to say that various modifications can be made thereto within the scope that does not substantially depart from the effects of the present invention.

### INDUSTRIAL APPLICABILITY

The present invention provides a touch input system, a touch input device, and a touch input auxiliary tool and has industrial applicability.

### DESCRIPTION OF REFERENCE NUMERALS

1: Touch input device
1a: Touch input surface
5, 5A, 5B, 5C: Touch input auxiliary tool
10: Detector
100: Touch input system
111: Function addition section
113: Input determination section
200: Touch input object

What is claimed is:

1. A touch input system comprising:
a touch input device; and
a touch input auxiliary tool, wherein
the touch input device includes:
a detector that has a touch input surface and detects touch input to the touch input surface by a touch input object or a position of the touch input auxiliary tool that is arranged on the touch input surface;
a function addition section that adds a touch input button function corresponding to the touch input auxiliary tool to a corresponding area that corresponds to the position of the touch input auxiliary tool on the touch input surface in a case where the detector detects the touch input auxiliary tool; and
an input determination section that determines that input is carried out by the touch input button function added to the corresponding area in a case where the detector detects the touch input to the corresponding area by the touch input object.

2. The touch input system according to claim 1, wherein
the function addition section adds the touch input button function to the corresponding area that is located directly under the touch input auxiliary tool, and
the detector detects the touch input to the corresponding area located directly under the touch input auxiliary tool via touch to an upper surface of the touch input auxiliary tool by the touch input object.

3. The touch input system according to claim 2, wherein
the touch input auxiliary tool is in a form of a sheet.

4. The touch input system according to claim 2, wherein
at least one of a type of the touch input button function that is added to the corresponding area and a range of the corresponding area is displayed on the touch input auxiliary tool.

5. The touch input system according to claim 1, wherein
the touch input button function includes an input function as an input device to a computer.

6. The touch input system according to claim 5, wherein
the touch input auxiliary tool has a form indicating the input device.

7. The touch input system according to claim 5, wherein
the touch input button function includes an input function as a keyboard.

8. The touch input system according to claim 5, wherein
the touch input button function includes an input function as a mouse.

9. The touch input system according to claim 5, wherein
the touch input button function includes an input function as a touchpad.

10. A touch input device comprising:
a detector that has a touch input surface and detects touch input to the touch input surface by a touch input object or a position of a touch input auxiliary tool that is arranged on the touch input surface;
a function addition section that adds a touch input button function corresponding to the touch input auxiliary tool to a corresponding area that corresponds to the position of the touch input auxiliary tool on the touch input surface in a case where the detector detects the touch input auxiliary tool; and
an input determination section that determines that input is carried out by the touch input button function added to the corresponding area in a case where the detector detects the touch input to the corresponding area by the touch input object.

11. A touch input auxiliary tool, which is detected by the detector of the touch input device according to claim 10 and associated with the touch input button function.
